(19) United States
(12) Patent Application Publication
(10) Pub. No.: US 2009/0095680 A1
(43) Pub. Date: Apr. 16, 2009

(54) Membrane Treatment Method and Membrane Treatment Apparatus Using Membrane Module

(76) Inventors: Masahiro Saito, Tokyo (JP); Gaku Taniguchi, Tokyo (JP); Taishi Sato, Tokyo (JP); Satoru Okada, Tokyo (JP)

Correspondence Address: CROCKETT & CROCKETT, P.C., 26020 ACERO, SUITE 200, MISSION VIEJO, CA, 92691, US

(21) Appl. No.: 12/293,210

(22) PCT Filed: Mar. 15, 2007
(86) PCT No.: PCT/JP2007/055293

§ 371 Date: Sep. 16, 2008

(30) Foreign Application Priority Data
Mar. 16, 2006 (JP) 2006-073464

(51) Int. Cl. B01D 61/14; B01D 61/18

(52) U.S. Cl. 210/650; 210/321.87

(57) ABSTRACT

[Problem] To provide a membrane treatment method and a membrane treatment apparatus using a membrane module, which are capable of reducing fouling using a simple installation, without increasing costs.

[Means for Solving the Problem] The membrane treatment method and membrane treatment apparatus using a membrane module according to the invention, having a membrane treatment tank 2 and a membrane module 1 centrally provided in the tank 2 for continuously performing filtration while raw water is being passed thereto; wherein raw water is introduced from the outside of the membrane treatment tank 2 toward the inside thereof along a direction tangent to a perimeter of the tank, to create a swirling flow in the tank 2.

### TECHNICAL FIELD

The present invention relates to a membrane treatment method and a membrane treatment apparatus using a membrane module, which are capable of preventing microorganisms and bacteria in seawater through membranes to thereby supply ballast water not containing microorganisms and the like with a predetermined size or more into ballast tanks. More particularly, the invention relates to a membrane treatment method and a membrane treatment apparatus using a membrane module, which are capable of filtering seawater with a low concentration of fouling substances through a membrane module, to thereby reduce the frequency of clarification and increase the recovery rate of treated water.

### BACKGROUND ART

Tankers and other cargo ships are furnished with ballast tanks for maintaining the stability of the ship during traveling. The ballast tanks are typically filled with water when the ship is not loaded with oil or other cargo, and emptied when the ship is loaded. The buoyancy of the ship is thus re-adjusted to stabilize the ship.

Ballast water, essential as above for the safety of seagoing vessels, is normally the seawater taken in at the ports where the ships are unloaded of their cargo. It is estimated that, worldwide, as much as well over 10,000,000,000 tons of seawater is being used annually for ballasting ships.

Ballast water contains microorganisms and eggs of large or small organisms, which inhabited the ports where the water was taken in. As the ship travels the oceans, such microorganisms and eggs of large or small organisms contained in the ballast water are also transported to foreign countries.

Therefore, exotic species, which have not originally inhabited the destination ports, replace the native species, causing serious destruction of the ecosystems.

In light of these situations, a diplomatic conference at International Maritime Organization (IMO) made it obligatory to conduct regular tests for ballast water treatment equipment and the like, and this obligation will apply to ships constructed after 2009.

The ballast water performance standards of the Convention for the Control and Management of Ships' Ballast Water and Sediments (hereinafter referred to as the Convention) require that ships conducting ballast water management shall discharge:

TABLE 1

| Items | Ballast Water Quality Criteria | Size |
|---|---|---|
| Plankton | 10 Unit/ml | 10 to 50 μm |
| Plankton | 10 Unit/m³ | 50 μm or more |
| Escherichia Coli | 250 cfu/100 ml | 0.5 to 3 μm |
| Vibrio Cholerae | 1 cfu/100 ml | 0.5 to 3 μm |
| Genus Enterococcus | 100 cfu/100 ml | 0.5 to 3 μm |

For these reasons, the development of a method for treating ballast water, which can reduce the concentration of microorganisms in ballast water to be discharged to approximately one hundredth of those in outer oceans, has become an urgent need. As a technique for disinfecting ballast water, a membrane treatment method using a membrane module has previously been proposed.

In membrane treatment methods, it is important to reduce fouling in order to extend the membrane treatment time, and patent document 1 discloses a technique for reducing fouling by utilizing expansion of bubbles by reducing pressure.

Patent document 1: JP 2003-265935 A

### DISCLOSURE OF THE INVENTION

### Problems to be Solved by the Invention

The technique disclosed in patent document 1 requires a pressure-reducing means to reduce pressure in the tank equipped with a membrane module, resulting in increased installation costs.

Accordingly, it is an object of the invention to provide a membrane treatment method and a membrane treatment apparatus using a membrane module, which are capable of reducing fouling using a simple installation, without increasing costs.

Other objects of the invention will become apparent from the following description.

### Means for Solving the Problems

The above-described object is solved by the inventions set forth below.

The invention according to claim 1 is a membrane treatment method using a membrane module, the method having a membrane treatment tank, and a membrane module centrally provided in the tank for continuously performing filtration while raw water is being passed thereto; the method comprising introducing raw water from the outside of the membrane treatment tank toward the inside thereof along a direction tangent to a perimeter of the tank, to create a swirling flow in the tank.

The invention according to claim 2 is a membrane treatment apparatus using a membrane module, the apparatus having a membrane treatment tank, and a membrane module centrally provided in the tank for continuously performing filtration while raw water is being passed thereto; the apparatus comprising a raw-water inlet pipe provided in the tank to introduce raw water from the outside of the membrane treatment tank toward the inside thereof along a direction tangent to a perimeter of the tank.

The invention according to claim 3 is a membrane treatment apparatus using a membrane module, the apparatus having a cylindrical membrane treatment tank, and a membrane module centrally provided in the tank for continuously performing filtration while raw water is being passed thereto; the apparatus comprising a raw-water inlet pipe provided at a lower or upper portion of a side wall of the tank to introduce raw water from the outside of the membrane treatment tank toward the inside thereof along a direction tangent to a perimeter of the tank; and a raw-water outlet pipe provided at an upper or lower portion of the side wall of the tank.

The invention according to claim 4 is the membrane treatment apparatus using a membrane module as defined in claim 1, 2, or 3, wherein the membrane treatment unit comprises a cylindrical membrane module or a rectangular membrane module.

### EFFECTS OF THE INVENTION

The invention provides a membrane treatment method using a membrane module, which is capable of reducing fouling using a simple installation, without increasing costs.

### BRIEF DESCRIPTION OF THE DRAWINGS

FIG. 1 is a schematic perspective view illustrating the membrane treatment method using a membrane module according to the invention, and an example of an apparatus for performing the method;

FIG. 2 is a diagram for use in explaining the state of a swirling flow; and

FIG. 3 is a diagram for use in explaining another preferred embodiment of the invention.

### EXPLANATION OF REFERENCE NUMERALS

1: membrane module
2: membrane treatment tank
   20: Sidewall
3: raw-water inlet pipe
4: raw-water outlet pipe
5: raw-water pump
6: circulation piping
7: outlet pipe for suspended solids
8: guide plate

### BEST MODE FOR CARRYING OUT THE INVENTION

Embodiments of the invention will hereinafter be described with reference to the drawings.

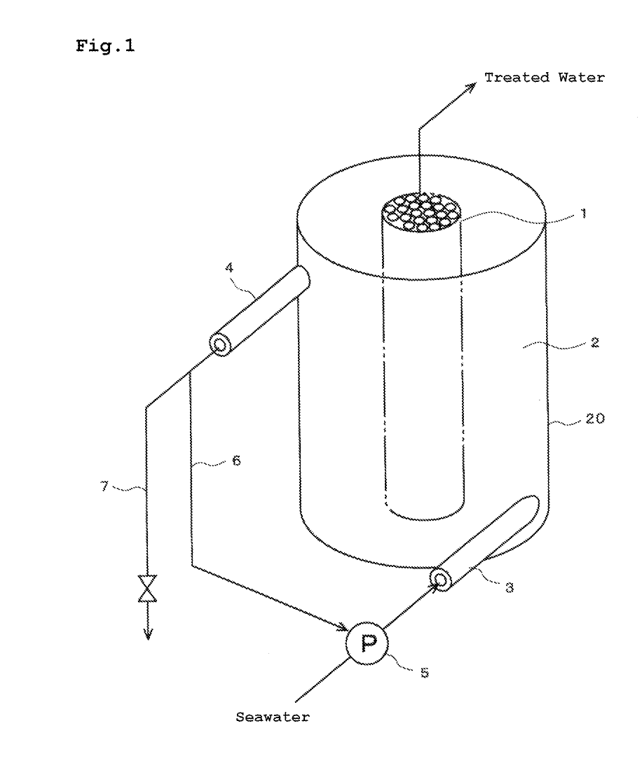

FIG. 1 a schematic perspective view illustrating the membrane treatment method using a membrane module according to the invention, and an example of an apparatus for performing the method.

In FIG. 1, reference numeral 1 denotes a membrane module that can be installed in vessels such as tankers and the like. Reference numeral 2 denotes a cylindrical membrane treatment tank having the membrane module 1 installed in the center thereof.

Reference numeral 3 denotes a raw-water inlet pipe, and numeral 4 denotes a raw-water outlet pipe. Reference numeral 5 denotes a raw-water pump, numeral 6 denotes circulation piping, and numeral 7 denotes an outlet pipe for suspended solids.

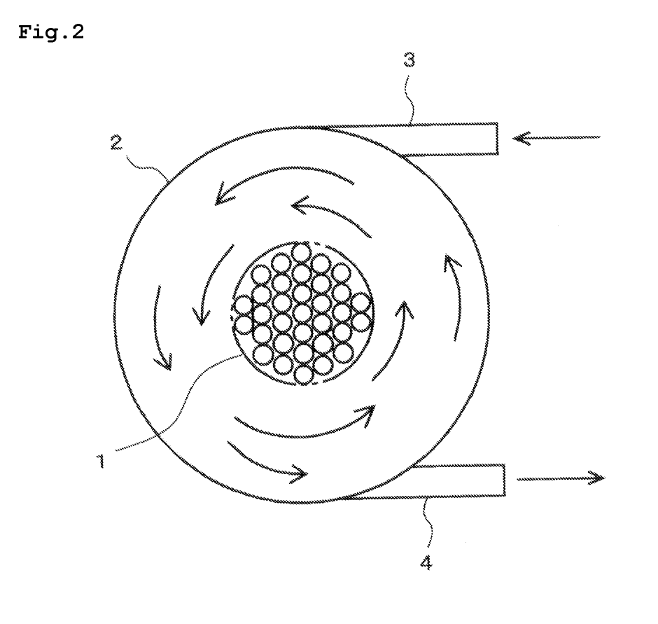

The raw-water inlet pipe 3 introduces raw water from the outside of the membrane treatment tank 2 toward the inside along the direction tangent to the perimeter of the tank, and is installed as illustrated in FIG. 2 in detail. The raw-water inlet pipe 3 may be linear near the region where it is joined to the tank 2, so as to introduce raw water in the direction tangent to the perimeter of the tank. The raw water introduced into the tank 2 creates a swirling flow, as illustrated in FIG. 2.

This swirling flow has a centrifugal separation effect, such that the fouling substances of high weights swirling around the sidewall of the tank are caused to move inward as their weights decrease (see the arrows).

Therefore, raw water swirling near the membrane module installed in the center of the tank 2 has a low concentration of fouling substances.

The membrane module can thus filter raw water with a low concentration of fouling substances, which are the cause of membrane clogging, and thereby extend the membrane treatment duration per circulation cycle. That is to say, the recovery efficiency (the recovery rate) of treated water increases.

The inventors conducted seawater filtration experiments using MF (microfiltration) membranes with a nominal pore size of 0.4 μm, to examine the filtration durations before and after the creation of a swirling flow as illustrated in FIG. 2. The filtration rate was set to 5 m/day (constant), and the time required until the differential pressure increased to 50 kPa was 30 minutes before creating a swirling flow, whereas the filtration duration after creating a swirling flow was from 40 to 50 minutes.

In another preferred embodiment of the invention, as illustrated in FIG. 1, when the raw-water inlet pipe 3 is provided at a lower portion of the side wall 20 of the tank 2, the raw-water outlet pipe 4 is provided at an upper portion of the side wall 20 of the tank 2. This arrangement is preferable because a swirling flow can be created in the entire tank 2, particularly in the horizontal and vertical directions. Although not illustrated, when the raw-water inlet pipe 3 is provided at an upper portion of the sidewall 20 of the tank 2, the raw-water outlet pipe 4 is preferably provided at a lower portion of the sidewall 20 of the tank 2.

While the raw water is introduced into the tank 2 and filtered, part of the water is discharged outside via the raw-water outlet pipe 4, passes through the circulation piping 6, and is introduced into the tank 2 again via the raw-water pump 5. When the concentration of suspended solids in the raw water circulating in the circulation piping 6 has increased, or when the raw water itself has a high concentration of suspended solids, the raw water is preferably discharged outside via the outlet pipe 7, so that the concentration of fouling substances in the raw water fed to the membranes is maintained low.

When ballast water is treated, the raw water fed to the tank 2 via the raw-water pump 5 is seawater or fresh water.

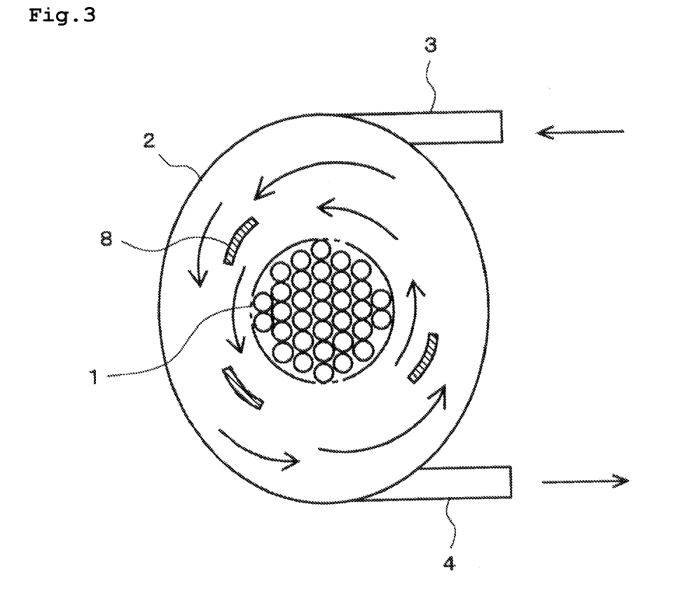

While the membrane treatment tank 2 is not particularly limited in shape, it is preferably cylindrical to create a favorable swirling flow in the tank. When the tank 2 has a shape other than cylindrical, such as oval or polygonal, guide plates 8 are preferably provided, as illustrated in FIG. 3, so as to facilitate creation of a swirling flow.

In the invention, the membrane module 1 may be a cylindrical membrane module or a rectangular membrane module.

Although the membrane module 1 allows the separation of microorganisms with a predetermined size or more, it is preferable to additionally perform ozonation to sterilize minute microorganisms (bacteria and the like) that have passed through the membranes, to thereby obtain clear ballast water.

1. A membrane treatment method comprising the steps of:
providing a membrane treatment tank;
providing a membrane module centrally positioned within the membrane tank, the membrane module adapted to continuously perform filtration while raw water is passed therethrough; and
introducing raw water from the outside of the membrane treatment tank toward the inside of the membrane treatment tank along a direction tangent to a perimeter of the tank to generate a swirling flow in the tank.

2. A membrane treatment apparatus that uses a membrane module comprising:
a membrane treatment tank;
a membrane module centrally positioned within the tank and operable to continuously perform filtration while raw water is passed therethrough; and
a raw-water inlet pipe positioned within the tank and operable to introduce raw water from the outside of the membrane treatment tank toward the inside thereof along a direction tangent to a perimeter of the tank.

3. A membrane treatment apparatus that uses a membrane module comprising:
a cylindrical membrane treatment tank; and
a membrane module centrally positioned within the tank and operable for continuous filtration while raw water is being passed therethrough;
a raw-water inlet pipe positioned in a lower portion of a side wall of the tank to introduce raw water from the outside of the membrane treatment tank to the inside thereof along a direction tangent to a perimeter of the tank; and
a raw-water outlet pipe positioned in an upper portion of the side wall of the tank.

4. The membrane treatment apparatus using a membrane module according to claim 1 wherein the membrane treatment unit comprises a cylindrical membrane module or a rectangular membrane module.

5. A membrane treatment apparatus that uses a membrane module comprising:
a cylindrical membrane treatment tank; and
a membrane module centrally positioned within the tank and operable for continuous filtration while raw water is being passed therethrough;
a raw-water inlet pipe located in an upper portion of a side wall of the tank to introduce raw water from the outside of the membrane treatment tank to the inside thereof along a direction tangent to a perimeter of the tank; and
a raw-water outlet pipe positioned in an upper portion of the side wall of the tank.
